(19) United States
(12) Patent Application Publication
(10) Pub. No.: US 2019/0065797 A1
(43) Pub. Date: Feb. 28, 2019

(54) TWO-AXIS ROTARY ADJUSTMENT DEVICE OF BARCODE READER SCANNING HEAD

(71) Applicant: POSIFLEX TECHNOLOGY, INC., New Taipei City (TW)

(72) Inventor: Tsung-Kan CHENG, TAIPEI (TW)

(21) Appl. No.: 16/111,241

(22) Filed: Aug. 24, 2018

(30) Foreign Application Priority Data
Aug. 25, 2017 (TW) 106129044

(51) Int. Cl. G06K 7/10

(52) U.S. Cl. CPC G06K 7/10623; G06K 7/10821

(57) ABSTRACT

A two-axis rotary adjustment device of a barcode reader scanning head includes a base having a vertical bearing, a U-shaped frame having a transversal beam and two side arms, the transversal beam including a vertical shaft formed on a top portion thereof and the vertical shaft pivotally connecting and clamping the vertical bearing so that the U-shaped frame is able to horizontally rotate on the base along a first axis, the side arms including two horizontal bearings aligning with each other, and a scanning head frame for storing the barcode reader scanning head, a scanning surface of the barcode reader scanning head facing outwardly, the scanning head frame including two horizontal shafts at two sides of the scanning head frame and aligning with each other, the horizontal shafts pivotally connecting to the horizontal bearings of the side arms respectively.

### RELATED APPLICATIONS

This application claims priority to Taiwan Application Serial Number 106129044, filed Aug. 25, 2017, which is herein incorporated by reference.

### TECHNICAL FIELD

The present disclosure generally relates to a barcode reader. More particularly, the present disclosure relates to a two-axis rotary adjustment device of a barcode reader scanning head for reading one dimensional (1D) barcodes or two dimensional (2D) Barcodes.

### BACKGROUND

A conventional barcode reader 500 includes a handheld type or a desktop type, and a scanning head 510 of the conventional barcode reader 500 is fixed in a single direction with the main body thereof. Therefore, the scanning head 510 of the conventional barcode reader 500 cannot read barcodes on products in different directions while the conventional barcode reader 500 is fixed on an equipment body 600 and the main body thereof is not movable. Accordingly, there is a need to improve the barcode reader.

### SUMMARY

One objective of the embodiments of the present invention is to provide a two-axis rotary adjustment device of a barcode reader scanning head. When a barcode reader is equipped on a stationary equipment body, the barcode reader scanning head is still able to adjust the direction thereof with the two-axis rotary adjustment device.

According to one embodiment of the present invention, a two-axis rotary adjustment device of a barcode reader scanning head for adjusting a direction of the barcode reader scanning head to read barcodes is provided. The two-axis rotary adjustment device includes a base having a vertical bearing, a U-shaped frame having a transversal beam and two side arms protruding downward and connecting to the transversal beam, the transversal beam including a vertical shaft formed on a top portion of the transversal beam, and the vertical shaft pivotally connecting and clamping the vertical bearing of the base so that the U-shaped frame is able to horizontally rotate on the base, wherein each of the side arms includes a horizontal bearing to align with each other, and a scanning head frame for storing the barcode reader scanning head, a scanning surface of the barcode reader scanning head facing outwardly, the scanning head frame including two horizontal shafts outwardly locating at two sides of the scanning head frame and aligning with each other, the horizontal shafts pivotally connecting and clamping the horizontal bearings of the side arms respectively so that the scanning head frame is able to vertically rotate on the side arms.

According to one embodiment of the present invention, a location of the vertical bearing and a location of the vertical shaft are interchangeable.

According to one embodiment of the present invention, locations of the horizontal bearings and locations of the horizontal shafts are interchangeable.

According to one embodiment of the present invention, a first opposite surface of the U-shaped frame pivotally couples to a second opposite surface of the base, and a horizontal rotating rack is fixed on the first opposite surface along a horizontally rotation circular path and a horizontal rotation elastic bump is formed on the second opposite surface to provide a step feeling while the horizontal rotation elastic bump climbs over teeth of the horizontal rotating rack.

According to one embodiment of the present invention, a third opposite surface of the scanning head frame pivotally couples to a fourth opposite surface of the U-shaped frame, a swing rotation rack is fixed on the third opposite surface along a swing rotation circular path and a swing rotation elastic bump is formed on the fourth opposite surface to provide a step feeling while the swing rotation elastic bump climbs over teeth of the swing rotation rack.

According to one embodiment of the two-axis rotary adjustment device of the scanning head of the barcode reader of the present invention, the U-shaped frame can horizontally rotate relative to the base and the head frame can swing relative to the U-shaped frame so that the barcode reader with the two-axis rotary adjustment device can equip on an equipment body with the base thereof to rotate the scanning head of the barcode reader for reading barcodes even when the base is fixed on the equipment body.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 illustrates a schematic perspective view showing a conventional barcode reader equipped on an equipment body;

FIG. 2 illustrates a schematic perspective view showing a base of a two-axis rotary adjustment device of a barcode reader scanning head according to one embodiment of the present invention;

FIG. 3 illustrates a schematic perspective view showing a U-shaped frame of a two-axis rotary adjustment device of a barcode reader scanning head according to one embodiment of the present invention;

FIG. 4 illustrates a schematic exploded perspective view showing a base and a U-shaped frame of a two-axis rotary adjustment device of a barcode reader scanning head according to one embodiment of the present invention;

FIG. 5 illustrates a schematic perspective view showing a scanning head frame of a two-axis rotary adjustment device of a barcode reader scanning head according to one embodiment of the present invention;

FIG. 6 illustrates a schematic perspective view showing a two-axis rotary adjustment device of a barcode reader scanning head according to one embodiment of the present invention;

FIG. 7 illustrates a schematic perspective view showing a two-axis rotary adjustment device of a barcode reader scanning head according to one embodiment of the present invention equipped on an equipment body;

FIG. 8 illustrates a schematic exploded perspective view showing a U-shaped frame and a base of a two-axis rotary adjustment device of a barcode reader scanning head according to one embodiment of the present invention equipped on an equipment body to demonstrate coupling surfaces therebetween; and

FIG. 9 illustrates a schematic cross-sectional view showing a scanning head frame and a U-shaped frame of a two-axis rotary adjustment device of a barcode reader scanning head according to one embodiment of the present invention equipped on an equipment body to demonstrate coupling surfaces therebetween.

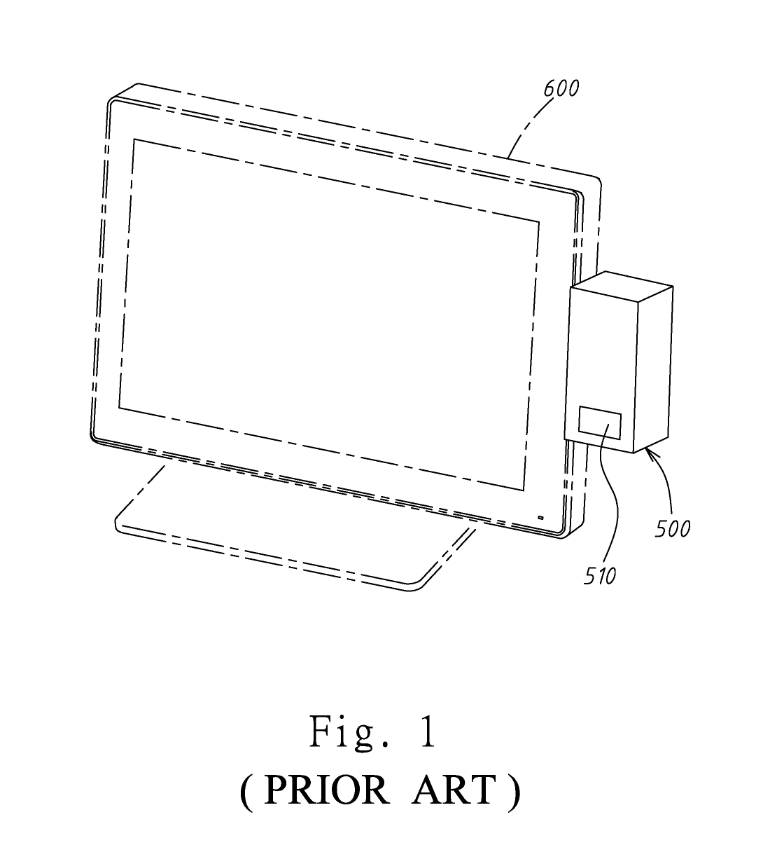

### DETAILED DESCRIPTION OF THE PREFERRED EMBODIMENT

The following description is of the best presently contemplated mode of carrying out the present disclosure. This description is not to be taken in a limiting sense but is made merely for the purpose of describing the general principles of the invention. The scope of the invention should be determined by referencing the appended claims.

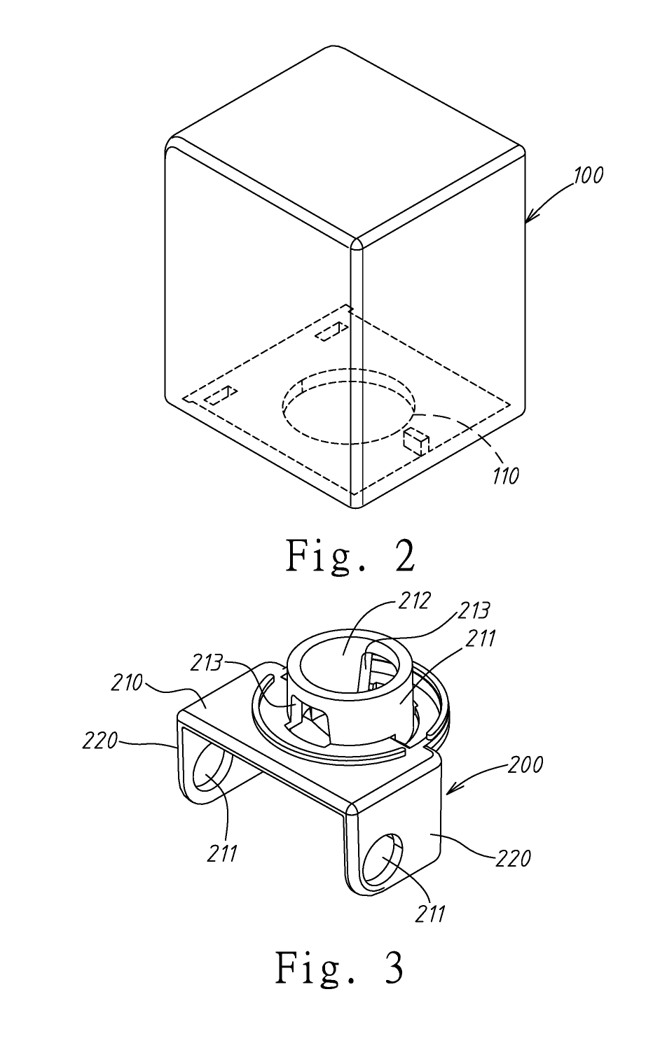

Refer to FIGS. 2-7. The two-axis rotary adjustment device of the scanning head of the barcode reader includes a base 100, a U-shaped frame 200 and a scanning head frame 300.

Simultaneously referring to FIG. 2, the base 100 is a part portion of the two-axis rotary adjustment device that equipped on the barcode reader. The base 100 is located at a bottom portion of the barcode reader. The base 100 includes a vertical bearing 110 as a bearing for horizontally rotating the U-shaped frame 200.

Simultaneously referring to FIG. 3, the U-shaped frame 200 includes a transversal beam 210, and two side arm 220 connecting to the transversal beam 210 and downward extending from two sides of the transversal beam 210. The upper portion of the transversal beam 210 includes a vertical shaft 211 with a through hole 212 therein to allow an electrical wire can pass through the vertical shaft 211. Two sides of the vertical shaft 211 includes two positioning slot 213 to allow the positioning ring 250 clamping the vertical shaft 211 in the vertical bearing 110 of the base 100. The side arms 220 respectively include a horizontal bearing 221 toward inside of the side arms 220 and aligning with each other for swing the scanning head frame 300 thereon.

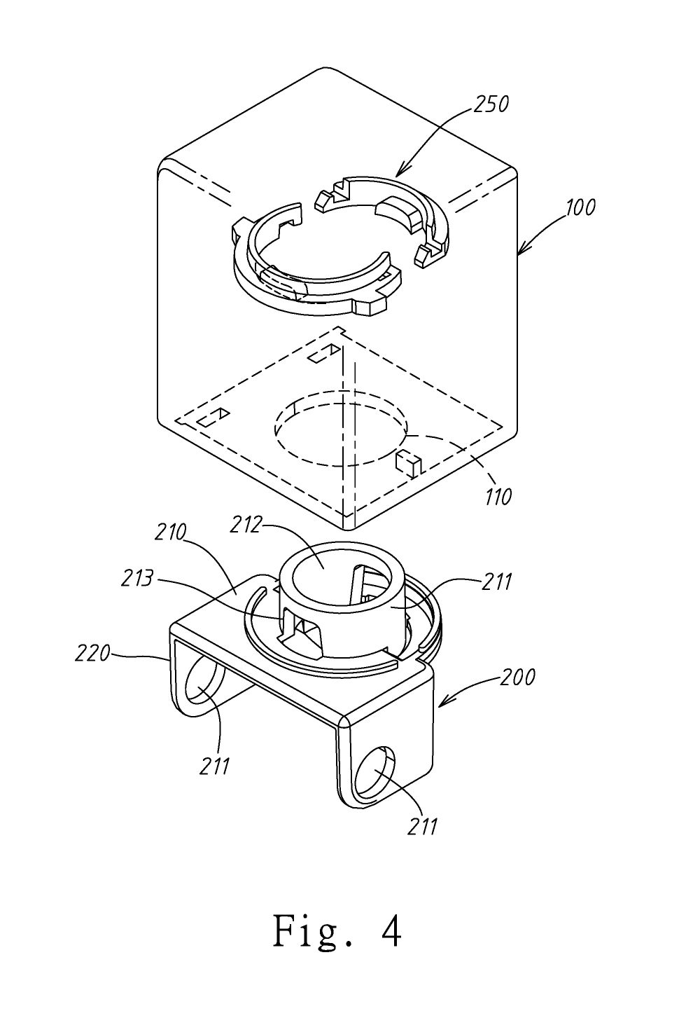

Simultaneously referring to FIG. 4, after the U-shaped frame 200 is pivoted on the vertical bearing 110 of the base 100 with the vertical shaft 211, the positioning ring 250 clamps the two positioning slot 213 of the vertical shaft 211 to rotatably fix the vertical shaft 211 on the vertical bearing 110 of the base 100. The positioning ring 250 is combined with two half rings to encircle on the vertical shaft 211. Accordingly, the U-shaped frame 200 is able to horizontally rotate on the base 100. Therefore, the two-axis rotary adjustment device of the scanning head of the barcode reader can rotate on an equipment body along a first axis.

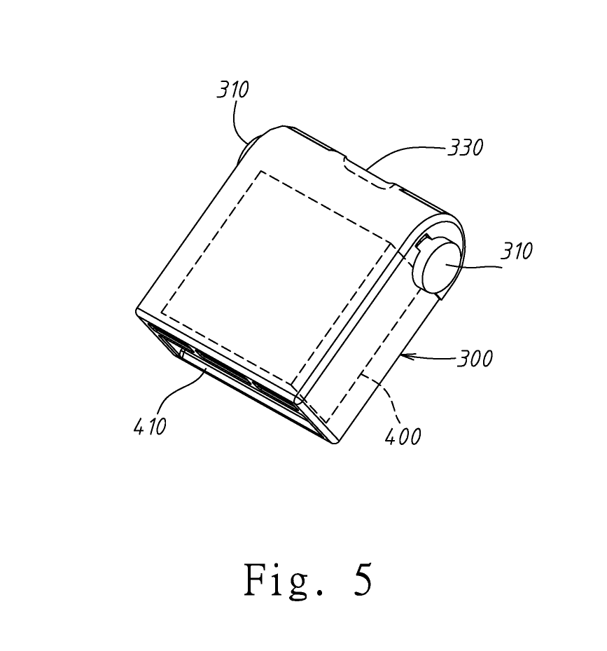

Simultaneously referring to FIG. 5, the scanning head frame 300 is utilized to store the scanning head 400 of the barcode reader to allow a scanning surface of the scanning surface 410 of the scanning head 400 downward facing the outside. An upper portion of the scanning head frame 300 includes a through opening 330 to allow the electrical wire of the scanning head 400 passing therethrough and the electrical wire then passes through the through hole 212 of the vertical shaft 211 to connect with an internal circuit of the barcode reader. The scanning head frame 300 has two horizontal shafts 310 outwardly locating at two sides of the scanning head frame 300 and aligning with each other.

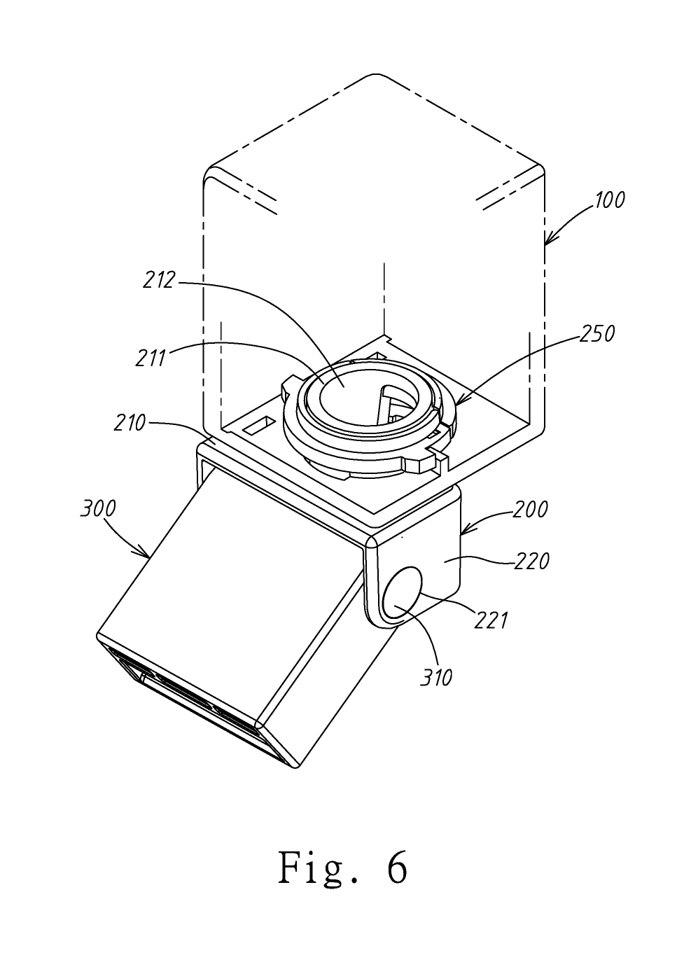

Simultaneously referring to FIG. 6, the horizontal shafts 310 of the scanning head frame 300 couple to the horizontal bearings 221 of the side arms 220 with the clamping force generated by the side arms 220 and the transversal beam 210 of the U-shaped frame 200 to allow the scanning head frame 300 vertically rotating on the side arms 220 along a second axis.

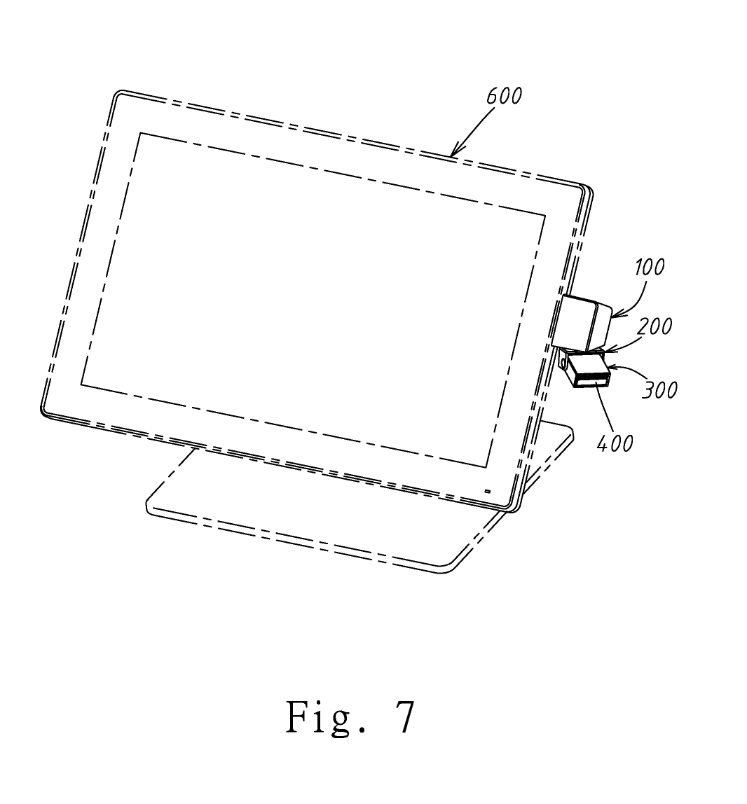

Accordingly, referring to FIG. 7, with the two-axis rotary adjustment device of the scanning head of the barcode reader, the scanning head 400 can be rotated along a vertical axis and a horizontal axis while the barcode reader is equipped on an equipment body 600.

A location of the vertical bearing 110 and a location of the vertical shaft 211 are interchangeable. Locations of the horizontal bearings 211 and locations of the horizontal shafts 310 are interchangeable.

The vertical or horizontal rotation of the scanning head 400 are relative to the U-shaped frame 200 and the scanning head frame 300 rather than limit to rotate with relative to the earth.

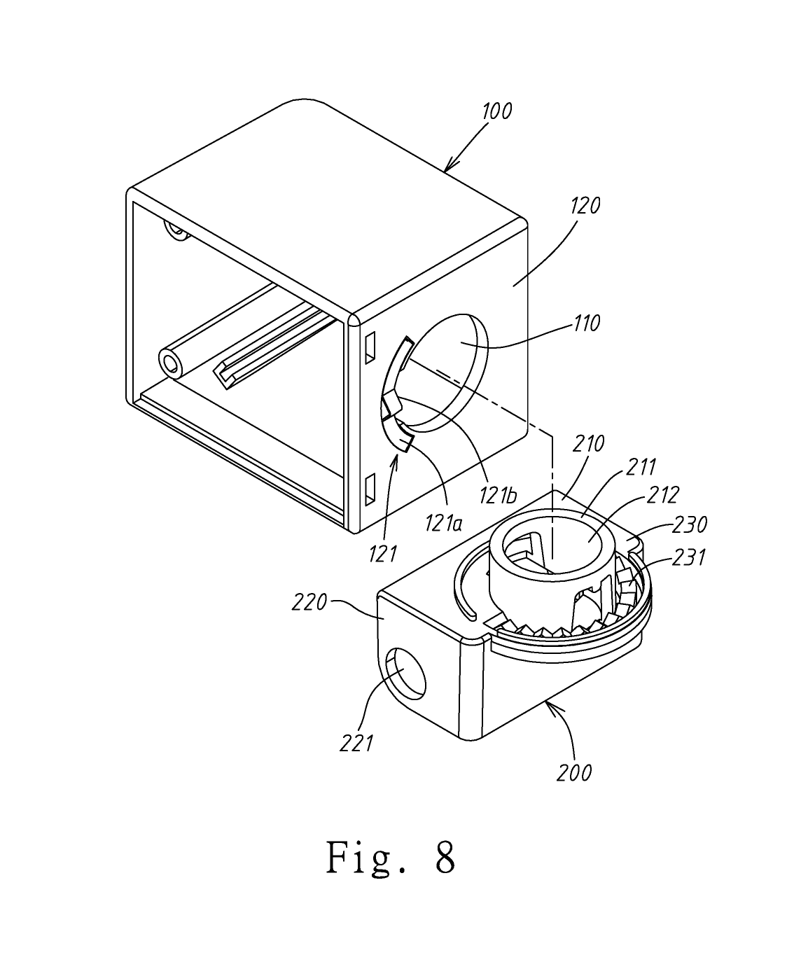

Simultaneously referring to FIG. 8, according to one embodiment of the present invention, the two-axis rotary adjustment device of the scanning head of the barcode reader can further equip with a step feeling device to improve the rotational feeling of the horizontal rotation. Therefore, a first opposite surface 230 of the U-shaped frame 200 pivotally couples to a second opposite surface 120 of the base 100 at the coupling position thereof. In addition, a horizontal rotating rack 231 is fixed on the first opposite surface 230 along a horizontally rotation circular path and a horizontal rotation elastic bump 121 is formed on the second opposite surface 120 to engage with the horizontal rotating rack 231. The horizontal rotation elastic bump 121 is formed by an elastic sheet metal 121a to make a raised triangle 121b and two ends of the raised triangle 121b are mounted in the base 100. When the horizontal rotation elastic bump 121 climbs over teeth of the horizontal rotating rack 231, the horizontal rotation elastic bump 121 and the horizontal rotating rack 231 can generate a desired step feeling.

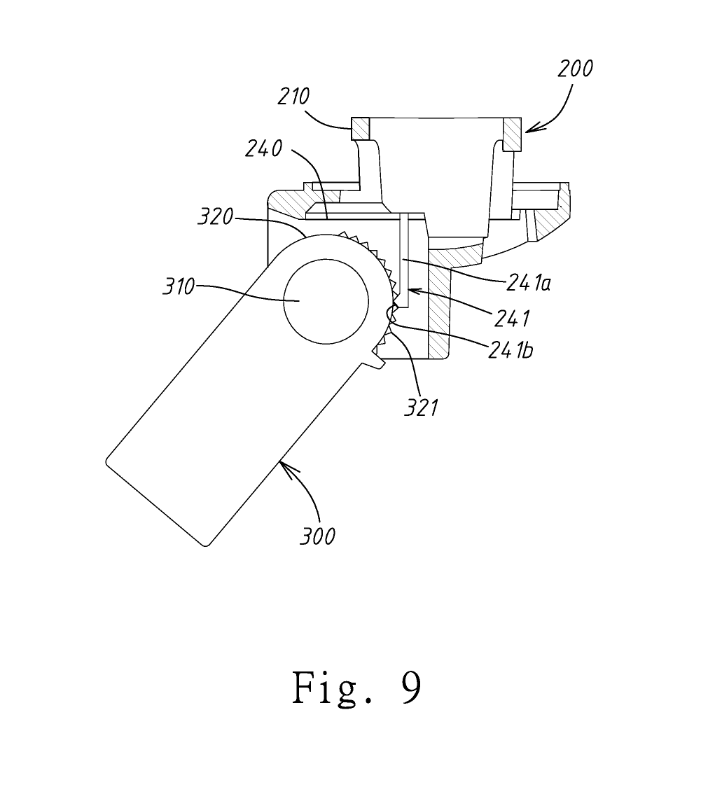

Simultaneously referring to FIG. 9, according to one embodiment of present invention, the two-axis rotary adjustment device of the scanning head of the barcode reader can further equip with a step feeling device to improve the rotational feeling of the swing rotation. Therefore, a third opposite surface 320 of the scanning head frame 300 pivotally couples to a fourth opposite surface 240 of the U-shaped frame 200 at the coupling position thereof. In addition, a swing rotation rack 321 is fixed on the third opposite surface 320 along a swing rotation circular path and a swing rotation elastic bump 241 is formed on the fourth opposite surface 240 to engage with the swing rotation rack 321.

The swing rotation elastic bump 241 is formed by an elastic-plastic sheet 241a to make a raised triangle 241b thereon, and the elastic-plastic sheet 241a is fixed to the U-shaped frame 200. When the swing rotation elastic bump 241 climbs over teeth of the swing rotation rack 321, the swing rotation elastic bump 241 and the swing rotation rack 321 can generate a desired step feeling.

What is claimed is:

1. A two-axis rotary adjustment device of a barcode reader scanning head for adjusting a direction of the barcode reader scanning head to read barcodes, the two-axis rotary adjustment device comprising:
a base having a vertical bearing;
a U-shaped frame having a transversal beam and two side arms protruding downward and connecting to the transversal beam, the transversal beam comprising a vertical shaft formed on a top portion of the transversal beam, and the vertical shaft pivotally connecting and clamping the vertical bearing of the base so that the U-shaped frame is able to horizontally rotate on the base, wherein the side arms comprise two horizontal bearings respectively extending inwardly and aligning with each other; and
a scanning head frame for storing the barcode reader scanning head, a scanning surface of the barcode reader scanning head facing outwardly, the scanning head frame comprising two horizontal shafts outwardly locating at two sides of the scanning head frame and aligning with each other, the horizontal shafts pivotally connecting and clamping the horizontal bearings of the side arms respectively so that the scanning head frame is able to vertically rotate on the side arms.

2. The two-axis rotary adjustment device of the barcode reader scanning head of claim 1, wherein a location of the vertical bearing and a location of the vertical shaft are interchanged.

3. The two-axis rotary adjustment device of the barcode reader scanning head of claim 1, wherein locations of the horizontal bearings and locations of the horizontal shafts are interchanged.

4. The two-axis rotary adjustment device of the barcode reader scanning head of claim 1, wherein a first opposite surface of the U-shaped frame pivotally couples to a second opposite surface of the base, and a horizontal rotating rack is fixed on the first opposite surface along a horizontally rotation circular path and a horizontal rotation elastic bump is formed on the second opposite surface to provide a step feeling while the horizontal rotation elastic bump climbs over teeth of the horizontal rotating rack.

5. The two-axis rotary adjustment device of the barcode reader scanning head of claim 1, wherein a third opposite surface of the scanning head frame pivotally couples to a fourth opposite surface of the U-shaped frame, a swing rotation rack is fixed on the third opposite surface along a swing rotation circular path and a swing rotation elastic bump is formed on the fourth opposite surface to provide a step feeling while the swing rotation elastic bump climbs over teeth of the swing rotation rack.
